(19) United States
(12) Patent Application Publication
(10) Pub. No.: US 2025/0011655 A1
(43) Pub. Date: Jan. 9, 2025

(54) RENEWABLE JET PRODUCTION FROM CATALYTIC PYROLYSIS FEEDSTOCK

(71) Applicant: IFP ENERGIES NOUVELLES, Rueil-Malmaison (FR)

(72) Inventors: Matthieu DREILLARD, Rueil-Malmaison Cedex (FR); Bertrand FANGET, Rueil-Malmaison Cedex (FR); Frederic FEUGNET, Rueil-Malmaison Cedex (FR); Jérôme BONNARDOT, Rueil-Malmaison (FR); Charles SORENSEN, Pearl River, NY (US); Anthony Rocco CARTOLANO, Pearl River, NY (US)

(73) Assignee: IFP ENERGIES NOUVELLES, Rueil-Malmaison (FR)

(21) Appl. No.: 18/710,960

(22) PCT Filed: Nov. 10, 2022
(86) PCT No.: PCT/EP2022/081446

§ 371 Date: May 16, 2024

Related U.S. Application Data
(60) Provisional application No. 63/280,326, filed on Nov. 17, 2021.

(51) Int. Cl. C10G 1/08; C10G 1/00; C10G 45/50; C10G 65/08

(52) U.S. Cl. CPC C10G 1/08; C10G 1/002; C10G 45/50; C10G 65/08; C10G 2300/1014; C10G 2300/301; C10G 2300/4006; C10G 2300/4012; C10G 2300/4018; C10G 2400/08

(57) ABSTRACT

The present invention provides a process comprising preparing renewable jet fuel blendstock by:
a. feeding biomass, catalyst, and optionally transport fluid to a catalytic pyrolysis process fluidized bed reactor maintained at reaction conditions to manufacture a raw fluid product stream containing renewable aromatics,
b. feeding the raw fluid product stream of a) to a solids separation and stripping system to produce separated solids and a fluid product stream,
c. feeding the fluid product stream of b) to a fractionation system in order to recover a fraction boiling at 180° C. to 300° C.,
d. hydrogenating at least a portion of the fraction generated in c) with hydrogen at hydrogenation conditions to produce a hydrogenated fraction containing naphthenes, suitable as jet fuel blendstock,
e. optionally recovering the jet fuel blendstock comprising naphthenes from the hydrogenated fraction of d) in a product recovery system.

### FIELD OF THE INVENTION

The present invention relates to an improved catalytic pyrolysis process. In particular, it relates to a process to produce renewable aviation fuel blendstocks and chemicals from renewable feedstocks via catalytic pyrolysis and hydrogenation of a naphthalene-rich oil phase, and to the chemicals, fuel blendstocks, and fuel compositions produced thereby.

### BACKGROUND OF THE INVENTION

A modern oil refinery converts crude oil through numerous unit operations and conversion reactions into several individual streams, including diesel, jet fuel, and gasoline blendstocks that are stored in separate tanks so they can be blended together in calculated proportions to obtain various grades of “finished” fuel grades that are used in cars, trucks, and aircraft.

In the United States there are additional laws that require gasoline, jet, and diesel fuels to contain renewable-sourced blendstocks between specific minimum and maximum levels. Today those limits are set by Congress via the Renewable Fuels Standards (“RFS”). The RFS mandates that 21 billion gallons of advanced biofuels will need to be produced by 2022. A part of these advanced biofuels will be fungible transportation fuels such as gasoline, jet fuel, and diesel derived from biomass. Efforts continue on producing such fuels from biomass to meet the mandate and it is perceived that there will be a strong demand for gasoline, jet, and diesel fuels produced economically from biomass. The chief renewable-sourced gasoline blendstock used in the U.S. to meet the gasoline blending requirement is ethanol, produced largely from corn or sugar fermentation. A minor, but growing contribution to the nation's renewable gasoline pool is so-called “second generation” cellulosic ethanol made from non-food biomass such as corn stover.

As described in the US DOE Office of Energy Efficiency and Renewable Energy (EERE) report “Sustainable Aviation Fuel: Review of Technical Pathways,” published in September 2020, the 106-billion-gallon global (21-billion-gallon domestic) commercial jet fuel market is projected to more than double by 2050. This market could consume several hundred million tons of biomass per year, which is consistent with the current availability of biomass in the United States (340 million tons/year). Cost-competitive, sustainable aviation fuels (SAFs) are recognized as a critical part of addressing this market growth. Renewable and/or waste carbon can provide a path to low-cost, clean-burning, and low-soot-producing jet fuels. Key to this fuel pathway is sourcing the three SAF blendstocks—iso-alkanes, cycloalkanes, and high-performing molecules—from inexpensive, renewable resources. When resourced from waste carbon, there are often additional benefits, such as cleaner water when sourcing carbon from wet sludges, or less waste going to landfills when sourcing the carbon from municipal solid waste.

Moreover, the price of SAF today is higher than petroleum-based Jet A fuel. Fuel price is a hurdle because fuel is 20%-30% of the operating cost of an airline.

For civilian or commercial aircraft, there are two main grades of jet fuel: Jet A-1 and Jet A. Jet fuels of both grades are kerosene-type fuel and the difference between them is that Jet A-1 fulfills the freezing point requirement of maximum −47° C., whereas Jet A fulfills the freezing point requirement of maximum −40° C. There is another grade of jet fuel: Jet B for usage in a very cold climate, a wide-cut fuel covering fractions from naphtha and kerosene, which fulfills the freezing point requirement of maximum −50° C.

Jet fuels consist of n-alkanes, iso-alkanes, cycloalkanes, and aromatics with from 5 to 16 carbon atoms. Aromatics do not burn as cleanly as alkanes, resulting in higher particulate emissions, and have lower specific energy. The n-alkanes are acceptable but do not meet fluidity and handling properties, limiting their blend potential. The iso-alkanes have high specific energy, good thermal stability, and low freezing points. Cycloalkanes bring complementary value to iso-alkanes, providing the same functional benefits as aromatics by enabling fuels to meet the density requirement and potentially providing the seal-swelling capacity provided today from aromatics. Combined, iso-alkanes and cycloalkanes offer the potential to add value to a fuel by enabling high specific energy and energy density and minimizing emission characteristics.

Cycloalkanes comprise a diverse spectrum of molecules and properties, in three classes: monocyclic, fused bicyclic, and strained molecules. Each of these cycloalkane classes has higher energy densities than typical Jet A fuel. Nominally, average Jet A fuel is approximately 25/7/0 wt % (weight %) monocyclic/fused bicyclic/strained cycloalkanes. Monocyclic alkanes can have a density, freeze point, flash point, and specific energy exceeding conventional fuel requirements. Processes for producing cyclohexane from benzene derived from renewable sources are the subject of U.S. Pat. Nos. 10,767,127, and 10,822,562.

Fused bicyclic alkanes in Jet A fuel are composed of naphthenes such as decalin (C₁₀H₁₈), the fully hydrogenated analogue of naphthalene (C₁₀H₈), often with additional carbons of varying alkyl lengths and branching. These fused bicyclic alkanes are characterized by high energy densities, specific energies similar to Jet A averages, and superior thermal stabilities. Decalin and monocyclic alkanes have shown similar swelling capabilities near those of Jet A fuel with aromatics, making them a potential replacement for the aromatic concentration minima previously mentioned. Tri- and tetra-cyclic materials such as phenanthrene, pyrene, chrysene, and fluoranthene are potential sources of polycyclic paraffins that could be part of a jet fuel blend. There are as of yet no processes for producing fused polycyclic aromatics from renewable materials that meet economic and environmental requirements.

In January 2020, ASTM approved a Fast Track Annex to D4054 (FIG. 9) that meets the strict compositional and performance requirements of conventional jet fuel and which limits the blend level to a maximum of 10% with Jet A or Jet A-1. Composition requirements include limits on the types of hydrocarbons in the blend. The cycloparaffin concentration must be less than 30 wt %, and the aromatic composition less than 20 wt %. Furthermore, tetralins and indanes (C₉H₁₀) must have a composition less than 6 wt % (or less than 30 wt % of the aromatics).

Biomass pyrolysis has been developing as an alternative for providing renewable fuels and fuel blendstocks. The product of biomass pyrolysis is a complex and unstable bio oil whose composition varies widely depending on feedstock and pyrolysis conditions, and that comprises hundreds of compounds including a plethora of oxygenates. Generally bio oil contains 20-40% by weight oxygen and a small percentage of sulfur-containing materials. Hydrotreatment of the bio oil, including hydrodeoxygenation (HDO), hydrodesulfurization (HDS), and olefin hydrogenation, is required to make the oil suitable as a blendstock or stand-alone fuel. While hydrotreating is well developed for petroleum feedstocks that contain almost no oxygen, the challenges of hydrotreating bio oil are more substantial. To date the preferred processes for hydrotreating bio oil are multi-stage systems that require high pressure of hydrogen, precious metal catalysts, and multiple unit operations (see for example, “Process Design and Economics for the Conversion of Lignocellulosic Biomass to Hydrocarbon Fuels: Fast Pyrolysis and Hydrotreating Bio-oil Pathway,” S. Jones et al, PNNL-23053, November 2013, available electronically at http://www.osti.gov/bridge).

Catalytic pyrolysis of biomass has been developed as an improved thermal process for upgrading biomass to chemicals and fuels. The process involves the conversion of biomass in a fluid bed reactor in the presence of a catalyst. The catalyst is usually an acidic, microporous crystalline material, usually a zeolite. The zeolite is active for the upgrading of the primary pyrolysis products of biomass decomposition, and converts them to aromatics, olefins, CO, CO₂, char, coke, water, and other useful materials. The aromatics include benzene, toluene, xylenes, (collectively BTX), and naphthalene, among other aromatics. The olefins include ethylene, propylene, and lesser amounts of higher molecular weight olefins. BTX aromatics are desirable products due to their high value and ease of transport. Toluene and xylenes are particularly desirable as gasoline components due to their high octane rating and energy density. Heavier aromatics are suitable precursors to jet and diesel fuels. When produced under proper conditions, the products of catalytic pyrolysis are very low in oxygen content.

US Patent Application US2020/0165527 describes isolation of a naphthalene-rich oil phase from a biomass catalytic pyrolysis process. No mention of hydrotreating or hydrogenating the naphthalene-rich oil phase or other materials containing polynuclear aromatics is made.

Previous publications have shown the efficacy of hydrotreating coal extracts, which contain similar bicylic naphthalenic and substituted naphthalenic structures, to produce a stream amenable to being used as a jet fuel. This application discloses a hydrogenation process to produce a jet fuel additive or blendstock nearly entirely derived from renewable feedstocks, such as loblolly pine from the Southeastern US or other similar biomass resources.

There are various technologies developed to convert biomass derived feedstocks to jet fuel, such as dehydration of alcohols, hydrogenation of oils, gasification, and conversion of sugars. All of these technologies involve multiple processing steps to create the jet fuel from renewable sources, none describe a one-step catalytic pyrolysis of woody biomass to create jet fuel precursors. Many such processes are described in detail in “Review of Biojet Fuel Conversion Technologies,” W-C Wang, et al, Technical Report NREL/TP-5100-66291, July 2016, wherein “solid-based feedstocks are converted into biomass-derived intermediate through gasification, into alcohols through biochemical or thermochemical processes, into sugars through biochemical processes, and into bio-oils through pyrolysis processes.” Wang indicates that “Bio-oil is a mixture of oxygenated organic species containing carbons ranging from C1 to C21+.” None of the processes considered by Wang is capable of converting solid feedstocks directly into very low oxygen content materials that merely need removal of residual heteroatoms such as S, N, and O, and saturation of specific aromatic fractions to produce a renewable jet fuel or jet fuel blendstock.

Zhang et al, in “Production of jet and diesel biofuels from renewable lignocellulosic biomass,” Applied Energy 150 (2015) 128-137, describe a multistep process for producing renewable jet fuel that includes catalytic pyrolysis of wood, followed by catalytic alkylation of the produced aromatics using ionic liquid catalysts and light (C2-C4) olefins in batch mode at 25-80° C. for 20-240 min, and hydrogenation of the resulting alkylated aromatics using 5 wt % Pd/activated carbon catalyst at 120-200° C. for six hours.

In U.S. Pat. Nos. 8,277,643; 8,864,984; 9,790,179; 10,370,601, 10,767,127; and 10,822,562, each incorporated herein by reference in its entirety, apparatus and process conditions suitable for catalytic pyrolysis are described.

In light of current commercial practices and the disclosures of art, a simple economical process for producing renewable jet fuel blending stocks or fuels that meet technical and regulatory limitations by use of a single step catalytic pyrolysis of biomass is needed. The present invention provides such a process and the resulting jet fuel blend compositions and chemicals.

### SUMMARY OF THE INVENTION

Various aspects of the present invention include production of jet fuel blendstocks and chemicals from renewable feedstocks via catalytic pyrolysis and hydrogenation of selected catalytic pyrolysis products or other processes. The present invention provides for this in an economical improved process.

In a first aspect, the invention provides an improved process for preparing renewable jet fuel blendstocks comprising the steps of: feeding a mixture comprising renewable aromatics to a fractionation system to recover a fraction, such as one boiling at or above 180° C. at atmospheric conditions, and a fraction boiling at or below 180° C. at atmospheric conditions, hydrogenating at least a portion of the recovered fraction of step a) boiling at or above 180° C. at atmospheric conditions to produce a hydrogenated fraction, and recovering a renewable fuel blendstock from the hydrogenated fraction of step b) in a product recovery system.

More particularly, the present invention comprises the steps of:
a. feeding biomass, catalyst composition, and transport fluid to a catalytic pyrolysis process fluidized bed reactor maintained at reaction conditions to manufacture a raw fluid product stream,
b. feeding the raw fluid product stream of step a) to a solids separation and stripping system to produce separated solids and a fluid product stream,
c. feeding the fluid product stream of step b) to a fractionation system in order to recover a fraction at or above 180° C.; preferably such as one boiling at 180° C. to 350° C.; much preferably such as one boiling at 180° C. to 320° C., much more preferably such as on boiling at 200 to 300° C.
d. hydrogenating at least a portion of the product stream generated in step c) with hydrogen at hydrogenation conditions to produce a hydrogenated fraction,
e. recovering fuel, such as jet fuel blendstock comprising naphthenes from the hydrogenated fraction of step d) in a product recovery system.

Boiling ranges presented in this invention refer to the boiling ranges under modest pressure operation, typically at or near atmospheric pressure, e.g. 0.1 Mpa.

### Glossary

As used herein, the term “biomass” has its conventional meaning in the art and refers to any organic source of energy or chemicals that is renewable. Its major components can be: (1) trees (wood) and all other vegetation; (2) agricultural products and wastes (corn stover, fruit, garbage ensilage, etc.); (3) algae and other marine plants; (4) metabolic wastes (manure, sewage), and (5) cellulosic urban waste, and carbonaceous urban waste. Examples of biomass materials are described, for example, in Huber, G. W. et al, “Synthesis of Transportation Fuels from Biomass: Chemistry, Catalysts, and Engineering,” Chem. Rev. 106, (2006), pp. 4044-4098.

Biomass is conventionally defined as the living or recently dead biological material that can be converted for use as fuel or for industrial production. The criterion as biomass is that the material should be recently participating in the carbon cycle so that the release of carbon in the combustion process results in no net increase of carbon participating in the carbon cycle averaged over a reasonably short period of time (for this reason, fossil fuels such as peat, lignite and coal are not considered biomass by this definition as they contain carbon that has not participated in the carbon cycle for a long time so that their combustion results in a net increase in atmospheric carbon dioxide). Most commonly, biomass refers to plant matter grown for use as biofuel, but it also includes plant or animal matter used for production of fibers, chemicals or heat. Biomass may also include biodegradable wastes or byproducts that can be burned as fuel or converted to chemicals, including municipal wastes, green waste (the biodegradable waste comprised of garden or park waste, such as grass or flower cuttings and hedge trimmings), byproducts of farming including animal manures, food processing wastes, sewage sludge, and black liquor from wood pulp or algae. Biomass excludes organic material which has been transformed by geological processes into substances such as coal, oil shale or petroleum. Biomass is widely and typically grown from plants, including miscanthus, spurge, sunflower, switchgrass, hemp, corn (maize), poplar, willow, sugarcane, and oil palm (palm oil) with the roots, stems, leaves, seed husks and fruits all being potentially useful. Processing of the raw material for introduction to the processing unit may vary according to the needs of the unit and the form of the biomass. Biomass can be distinguished from fossil-derived carbon by the presence of 14C in amounts significantly above that found in fossil fuels as determined by ASTM method D 6866-06.

Biomass used in the present process can most preferably be solid materials chosen from among wood, forestry waste, corn stover, agricultural solid waste, municipal solid waste, digestate, food waste, animal waste, carbohydrate, lignocellulosic material, xylitol, glucose, cellobiose, hemicellulose, lignin, and combinations thereof.

The term “renewable” refers to a substance that is derived from biomass; preferably containing at least 50 mass % C derived from biomass, or at least 80 mass % C derived from biomass, and typically 90 to 100% of the C being derived from biomass.

The term “naphthalene-rich oil” resulting from biomass conversion in catalytic pyrolyzing as used herein includes naphthalene, methyl-naphthalenes (e.g., 1-methyl naphthalene, 2-methyl naphthalene, etc.), dimethyl-naphthalenes (e.g., 1,5-dimethylnaphthalene, 1,6-dimethylnaphthalene, 2,5-dimethylnaphthalene, etc.), ethyl-naphthalenes, other polyaromatic compounds (e.g., anthracene, 9,10-dimethylanthracene, pyrene, phenanthrene, etc.) and aromatics and polyaromatics that contain a heteroatom (e.g., oxygen, sulfur, nitrogen, etc.). The naphthalene-rich oil is a stream typically boiling in a temperature range of from about 180 to about 575° C. This stream is resulting from the biomass conversion in the catalytic pyrolyzing process.

Naphthalene rich cut comprises at least 25, or at least 35, or at least 40, or from 25 to 90, or from 35 to 80, or from 40 to 75 wt % sum of naphthalene, substituted naphthalenes, naphthalenols, methyl naphthalenols, and naphthalene diols, and at least 3, or at least 5, or at least 6, or from 3 to 15, or from 5 to 10, or from 6 to 8 weight % xylenols, and less than 15, or less than 10, or less than 5, or from 0.01 to 20, or from 1 to 15, or from 5 to 13 weight % the sum of phenanthrene, anthracene, and other materials.

The term “off gas” as used herein includes H₂, CO, CO₂, N₂ and hydrocarbons containing 1 to 6 atoms of carbon (e.g., methane, ethane, ethylene, propane, propylene, n-butane, isobutane, isobutene, I-butene, 2-butene, pentane, pentene, hexane, hexene, etc.).

The term “tars” or “tar” as used herein is a stream typically boiling in a temperature range of from about 310 to about 575° C., the stream is usually dark brown or black, bituminous, and viscous.

As used herein, the terms “aromatics” or “aromatic compound” refer to a hydrocarbon compound or compounds comprising one or more aromatic groups such as, for example, single aromatic ring systems (e.g., benzyl, phenyl, etc.) and fused polycyclic aromatic ring systems (e.g., naphthyl, 1,2,3,4-tetrahydronaphthyl, etc.). Examples of aromatic compounds include, but are not limited to, benzene, phenol, benzenediols, benzenetriols, toluene, cresols, methoxy benzene, methylbenzene-diols, ethyl benzene, xylenes, styrene, 2,3-dihydro-benzofuran, methyl-benzenemethanol, dimethyl phenols, ethyl-phenols, dimethyl-benzenediols, ethylcatechol, resorcinol monoacetate, benzofuran, 3,4-dihydroxyethylbenzene, phorone, ethyl-toluenes, propyl-benzenes, trimethyl-benzenes, benzene-1-ethyl-4-methoxy, phenol-2,3,6-trimethyl, phenol-4-ethyl-2-methoxy, α-methyl styrene, methyl-styrenes, 1-propenyl benzene, 2-propenyl benzene, indane, 2,3-dihydro-1H-inden-5-ol, 1,2-indandiol, methyl 3-hydroxy-2-methylbenzoate, 4-(2-propenyl)-phenol, (2e)-3-phenylprop-2-enal, indene, phenol-2-(2-propynyl), methyl-benzofurans, 1H-indenol, 2-methyl benzothiophene, 1-methyl-4-propylbenzene, 1-methyl-4-(propan-2-yl)benzene, 4-isopropylbenzyl alcohol, 5-isopropyl-2-methylphenol, carvacrol, 2,3,5,6-tetramethyl-1,4-benzenediol, 1,2,3,4-tetrahydronaphthalene, methyl indanes, 2,4-dimethyl styrene, 1-ethenyl-4-ethylbenzene, 2-methyl 1-propenyl benzene, 2,3-dihydro-5-methyl-1H-indene, 5-methoxyindan, 1,5-dihydroxy-1,2,3,4-tetrahydronaphthalene, benzene, (1-methyl-2-cyclopropen-1-yl), 1-methyl indene, 2-methyl indene, 3-methyl indene, 4-methyl indene, 1,2-dihydro naphthalene, 1,4-dihydro naphthalene, 5,8-dihydro-1-naphthalenol, 2-methyl-1-indanone, 2,3-dimethyl benzofuran, naphthalene, naphthalenols, pentamethyl-benzene, methyl-tetralins, 2,2-dimethyl indane, 1H-indene 1-ethyl-2,3-dihydro, dimethyl-indenes, ethyl-indenes, dihydro-methylnaphthalenes, methyl naphthalenes, methyl-naphthols, 1-phenylcyclohexene, ethyl-naphthalenes, dimethyl-naphthalenes, biphenyl, acenaphthene, dibenzofuran, 2-(1-methylethyl)-naphthalene, trimethyl-naphthalenes, trimethyl azulene, 3-methyl-1,1-biphenyl, fluorene, 2-phenanthrenyl-1,2,3,4-tetrahydro, 9h-fluorene-1-methyl-, 9H-fluorene-2-methyl, 9H-fluorene-4-methyl, anthracene, phenanthrene, 3-phenanthrol, methyl-anthracenes, 2,6-dimethyl phenanthrene, 2-phenyl-naphthalene, pyrene, 1-benzyl naphthalene, 7H-benzo-[c]-fluorene, 11H-benzo-[b]-fluorene, 1-methyl-7-isopropyl phenanthrene, 1 4-dimethyl-2-phenyl naphthalene, chrysene, aniline, pyridine, pyrole.

Single ring and/or higher ring aromatics may also be produced in some embodiments. Aromatics also include single and multiple ring compounds that contain heteroatom substituents, i.e., phenol, cresol, benzofuran, aniline, indole, etc. Renewable aromatics are those materials above that have been prepared from renewable resources such as biomass.

The term “naphthenes” as used herein includes compounds having at least one saturated paraffinic ring, such as hydrocarbon ring compounds of the general formula, CₙH₂ₙ, including cyclopentane, cyclohexane, and cycloheptane, alkylated cycloparaffins such as methyl-, ethyl-, dimethyl-, propyl-, trimethyl-, and butyl-cyclohexanes, cyclopentanes, and cycloheptanes, and multi-ring cycloparaffins such as decalin, alkylated decalins, tetralin, and alkylated tetralins.

As used herein, the terms “olefin” or “olefin compound” (a.k.a. “alkenes”) have their ordinary meaning in the art, and refer to any unsaturated hydrocarbon containing one or more pairs of carbon atoms linked by a double bond. Olefins include both cyclic and acyclic (aliphatic) olefins, in which the double bond is located between carbon atoms forming part of a cyclic (closed ring) or of an open chain grouping, respectively. In addition, olefins may include any suitable number of double bonds (e.g., monoolefins, diolefins, triolefins, etc.). Examples of olefin compounds include, but are not limited to, ethene, propene, allene (propadiene), 1-butene, 2-butene, isobutene (2-methylpropene), butadiene, and isoprene, among others. Examples of cyclic olefins include cyclopentene, cyclohexene, and cycloheptene, among others. Aromatic compounds such as toluene are not considered olefins; however, olefins that include aromatic moieties are considered olefins, for example, benzyl acrylate or styrene.

As used herein, the term “oxygenate” includes any organic compound that contains at least one atom of oxygen in its structure such as alcohols (e.g., methanol, ethanol, etc.), acids (e.g., acetic acid, propionic acid, etc.), aldehydes (e.g., formaldehyde, acetaldehyde, etc.), esters (e.g., methyl acetate, ethyl acetate, etc.), ethers (e.g., dimethyl ether, diethyl ether, etc.), aromatics with oxygen containing substituents (e.g., phenol, cresol, benzoic acid, naphthol, etc.), cyclic ethers, acids, aldehydes, and esters (e.g. furan, furfural, etc.), and the like.

As used herein, the terms “phenolic oil” and “oxygenated oil” include aromatics with oxygen containing substituents (e.g., phenol, m-cresol, o-cresol, p-cresol, xylenols, etc.) and other compounds from Bio-TCat reactor effluent typically boiling in the range from 80 to 220° C. (e.g. benzene, toluene, p-xylene, m-xylene, a-xylene, indane, indene, 2-ethyl toluene, 3-ethyl toluene, 4-ethyl toluene, 1,3,5-trimethyl benzene, 1,2,4-trimethyl benzene, 1,2,3-trimethyl benzene, ethylbenzene, styrene, cumene, propyl-benzene, naphthalene, etc). The phenolic oil and the oxygenated oil are streams typically boiling in a temperature range from 80 to 220° C.

As used herein, the terms “pyrolysis” and “pyrolyzing” have their conventional meaning in the art and refer to the transformation of a compound, e.g., a solid hydrocarbonaceous material, into one or more other substances, e.g., volatile organic compounds, gases and coke, by heat, preferably without the addition of, or in the absence of, molecular oxygen, i.e. O₂. Preferably, the volume fraction of oxygen present in a pyrolysis reaction chamber is 0.5% or less. Pyrolysis may take place with or without the use of a catalyst. “Catalytic pyrolysis” refers to pyrolysis performed in the presence of a catalyst, and may involve steps as described in more detail below. Catalytic pyrolysis (also called catalytic fast pyrolysis or CFP) that involves the conversion of biomass in a catalytic fluid bed reactor to produce a mixture of aromatics, olefins, and a variety of other materials is a particularly beneficial pyrolysis process. Examples of catalytic pyrolysis processes are outlined, for example, in Huber, G. W. et al, “Synthesis of Transportation Fuels from Biomass: Chemistry, Catalysts, and Engineering,” Chem. Rev. 106, (2006), pp. 4044-4098, incorporated herein by reference. Products from a catalytic pyrolysis process may include materials such as benzene, phenol, benzenediols, benzenetriols, toluene, cresols, methoxy benzene, methylbenzene-diols, ethyl benzene, xylenes, styrene, 2,3-dihydro-benzofuran, methyl-benzenemethanol, dimethyl phenols, ethyl-phenols, dimethyl-benzenediols, ethylcatechol, resorcinol monoacetate, benzofuran, 3,4-dihydroxyethylbenzene, phorone, ethyl-toluenes, propyl-benzenes, trimethyl-benzenes, benzene-1-ethyl-4-methoxy, phenol-2,3,6-trimethyl, phenol-4-ethyl-2-methoxy, α-methyl styrene, methyl-styrenes, 1-propenyl benzene, 2-propenyl benzene, indane, 2,3-dihydro-1H-inden-5-ol, 1,2-indandiol, methyl 3-hydroxy-2-methylbenzoate, 4-(2-propenyl)-phenol, (2e)-3-phenylprop-2-enal, indene, phenol-2-(2-propynyl), methyl-benzofurans, 1H-indenol, 2-methyl benzothiophene, 1-methyl-4-propylbenzene, 1-methyl-4-(propan-2-yl)benzene, 4-isopropylbenzyl alcohol, 5-isopropyl-2-methylphenol, carvacrol, 2,3,5,6-tetramethyl-1,4-benzenediol, 1,2,3,4-tetrahydronaphthalene, methyl indanes, 2,4-dimethyl styrene, 1-ethenyl-4-ethylbenzene, 2-methyl 1-propenyl benzene, 2,3-dihydro-5-methyl-1H-indene, 5-methoxyindan, 1,5-dihydroxy-1,2,3,4-tetrahydronaphthalene, benzene, (1-methyl-2-cyclopropen-1-yl), 1-methyl indene, 2-methyl indene, 3-methyl indene, 4-methyl indene, 1,2-dihydro naphthalene, 1,4-dihydro naphthalene, 5,8-dihydro-1-naphthalenol, 2-methyl-1-indanone, 2,3-dimethyl benzofuran, naphthalene, naphthalenols, pentamethyl-benzene, methyl-tetralins, 2,2-dimethyl indane, 1H-indene 1-ethyl-2,3-dihydro, dimethyl-indenes, ethyl-indenes, dihydro-methylnaphthalenes, methyl naphthalenes, methyl-naphthols, 1-phenylcyclohexene, ethyl-naphthalenes, dimethyl-naphthalenes, biphenyl, acenaphthene, dibenzofuran, 2-(1-methylethyl)-naphthalene, trimethyl-naphthalenes, trimethyl azulene, 3-methyl-1,1-biphenyl, fluorene, 2-phenanthrenyl-1,2,3,4-tetrahydro, 9h-fluorene-1-methyl-, 9H-fluorene-2-methyl, 9H-fluorene-4-methyl, anthracene, phenanthrene, 3-phenanthrol, methyl-anthracenes, 2,6-dimethyl phenanthrene, 2-phenyl-naphthalene, pyrene, 1-benzyl naphthalene, 7H-benzo-[c]-fluorene, 11H-benzo-[b]-fluorene, 1-methyl-7-isopropyl phenanthrene, 1 4-dimethyl-2-phenyl naphthalene, chrysene, aniline, pyridine, pyyrole, among others.

Hydroprocessing, the reaction of organic materials with hydrogen, includes the processes of hydrotreating, hydrogenation, and hydrocracking. As used herein, the term hydrotreatment refers to a relatively mild hydroprocessing process for reacting organic feed materials with hydrogen used to remove at least 90% of contaminants such as nitrogen, sulfur, and oxygen from organic liquid fractions. These contaminants can have detrimental effects on the equipment, the catalysts, and the quality of the finished product. Hydrotreating also saturates a substantial portion of the olefinic portions of many materials to the corresponding material where the olefinic portion has been converted to its paraffinic counterpart, for example 1-hexene may be saturated to hexane, and styrene may be saturated to ethylbenzene. Hydrotreating does not significantly saturate aromatic portions of materials such as benzene to cyclohexane, i.e. the saturation of aromatic rings is less than 10% of the aromatic rings in the material. Hydrotreating is done prior to processes such as hydrogenation so that the hydrogenation catalyst is not contaminated by the contaminants in untreated feedstock. Hydrotreating is also used prior to catalytic cracking or hydrocracking to reduce sulfur and improve product yields, and to upgrade petroleum fractions into finished jet fuel, diesel fuel, and heating fuel oils.

Suitable hydrotreating catalysts for use in the hydrotreater are known conventional hydrotreating catalysts and include those which are comprised of at least one Group VIII metal (i.e., iron, cobalt, nickel, ruthenium, rhodium, palladium, osmium, iridium, or platinum, preferably iron, cobalt, or nickel, more preferably cobalt and/or nickel) and at least one Group VI metal (preferably molybdenum or tungsten or both) on a high surface area support material, preferably alumina or silica or a mixture of alumina and silica. Other suitable hydrotreating catalysts include zeolitic catalysts, as well as noble metal catalysts where the noble metal is selected from one or more of rhodium, ruthenium, iridium, palladium, and platinum. It is within the scope of the processes herein that more than one type of hydrotreating catalyst be used in the same reaction vessel. The Group VIII metal is typically present in an amount ranging from about 0.5 to about 20 weight percent, preferably from about 0.5 to about 10 weight percent. The Group VI metal will typically be present in an amount ranging from about 1 to 25 weight percent, and preferably from about 1 to 12 weight percent. While the above describes some exemplary catalysts for hydrotreating, other hydrotreating and/or hydrodesulfurization catalysts may also be used depending on the particular feedstock and the desired effluent quality. Catalysts and hydrotreating conditions can be selected to achieve less than 10%, or less than 5%, or less than 2%, or less than 1% hydrogenation of the aromatic carbon-carbon bonds in the aromatic rings in the feed to the hydrotreater.

The reaction conditions employed for hydrotreatment will depend in part on the particular reactor design selected and concentrations of the individual species, but reaction temperatures of 200° C. to 400° C. and hydrogen pressures of 4.0 MPa (40 bar) to 12 MPa (120 bar) are normally preferred. Advantageously, this contacting step may be carried out at a liquid hourly space velocity greater than 0.1 hr-1. The volumetric ratio of gas to liquid (the “G: L ratio”) in the hydrotreater at reactor operating conditions can range from 0.1 to 20:1, more typically 0.1 to 10:1.

As used herein, the term hydrogenation refers to a hydroprocessing process for reacting organic feed materials with hydrogen to saturate a substantial portion of the aromatic rings in a feed mixture. Hydrogenation may convert materials with more than one aromatic ring to materials wherein one or more of the aromatic rings have been saturated. For example, conversion of naphthalene with hydrogen to tetralin, or decalin, or a mixture of tetralin and decalin, is a hydrogenation process. Typically, the conversion of aromatic rings in a material to produce naphthenes is at least 15%, or at least 25% or at least 35%, or from 15 to 99%, or from 25 to 90%, or from 35 to 85% of the aromatic rings in the mixture. Typical process conditions for hydrogenation include temperatures of at least 280° C., or at least 300° C., or at least 320° C., or from 280 to 450° C., or from 300 to 400° C., or from 320 to 350° C. Typical hydrogen pressures for hydrogenation of aromatic rings includes pressures of at least 4 MPa, or at least 6 MPa, or at least 8 MPa, or from 4 to 20 MPa, or from 6 to 15 MPa, or from 8 to 12 MPa. Typical liquid hourly space velocities for hydrogenation are at least 0.5, or at least 1, or at least 2, or no more than 10, or no more than 5, or no more than 3, or from 0.5 to 5, or 1 to 4, or 2 to 3 hr-1 where the liquid hourly space velocity is the ratio of the volume of liquid feed fed over the catalyst per hour to the volume of catalyst in the reactor. Typical hydrogen circulation rates for hydrogenation are at least 100, or at least 1000, or at least 2000, or from 100 to 5000, or 1000 to 4500, or 2000 to 4000 Nm3 of H₂ per m3 of liquid feed. Typical catalysts for hydrogenation include CoMo, NiMo, Pt, Pd, Rh, Ru, or combinations thereof.

Catalyst components useful in the context of this invention can be selected from any catalyst known in the art, or as would be understood by those skilled in the art. Catalysts promote and/or effect reactions. Thus, as used herein, catalysts lower the activation energy (increase the rate) of a chemical process, and/or improve the distribution of products or intermediates in a chemical reaction (for example, a shape selective catalyst). Examples of reactions that can be catalyzed include: dehydration, dehydrogenation, hydrogenation, isomerization, oligomerization, cracking, hydrogen transfer, aromatization, cyclization, decarbonylation, decarboxylation, aldol condensation, molecular cracking and decomposition, combinations thereof, and other reactions. Catalyst components can be considered acidic, neutral, or basic, as would be understood by those skilled in the art.

### DETAILED DESCRIPTION OF THE INVENTION

As a result of extensive research in view of the above, we have found that we can economically and effectively conduct a catalytic pyrolysis process to enhance manufacture of valuable fuel blendstock and chemical products by way of a series of sequential steps. An embodiment of the present improved process comprises steps of:
a. feeding biomass, such as, for example, that provided from renewable sources of organic materials, catalyst composition, such as comprising one or more crystalline molecular sieves, for example, those characterized by a molar silica to alumina ratio (SAR) greater than 12 and a Constraint Index (CI) from 1 to 12, and transport fluid to a fluidized bed reactor maintained at reaction conditions, for example, a temperature from 300 to 1000° C. and pressure from 0.1 to 1.5 MPa, to manufacture a raw fluid product stream,
b. feeding the raw fluid product stream of step a) to a solids separation and stripping system, to produce separated solids and a fluid product stream,
c. feeding the fluid product stream of step b) to a fractionation system in order to recover a fraction such as one boiling at 180° C. to 350° C. preferably such as one boiling at 180° C. to 320° C., more preferably such as one boiling at 200 to 310° C.
d. hydrogenating at least a portion of the high boiling fraction of step c) at hydrogenation conditions to produce a hydrogenated fraction, and
e. recovering fuel blendstock, such as jet fuel blendstock, comprising less than 0.4 weight % olefins, less than 10 ppm (parts per million) by weight sulfur, less than 10 ppm by weight nitrogen, and less than 1 weight % oxygen, from the hydrogenated fraction of step d) in a product recovery system.

Embodiments of the invention include the novel fuel blendstocks recovered by step e) and mixtures thereof with fuels, such as jet fuel or other fuel blendstocks.

Hydrotreating and hydrogenation of a portion of a biomass catalytic pyrolysis product can efficiently hydrogenate C10-C16 aromatic components to produce a renewable jet fuel additive or blendstock. The key defining parameter for efficiently producing this material is to remove 3-ring species from the feed to the hydrogenation, so as to avoid fouling of the catalyst. This can be done by limiting the ending boiling point of the distilled product to no more than 310-320° C., preferably 300-310° C. so as to minimize the presence of compounds such as phenanthrene, anthracene, and related compounds.

In one embodiment of the invention the renewable fuel blendstock comprises at least 50, or at least 75, or at least 90, or from 50 to 99, or from 75 to 95% by weight hydrocarbons with from 10 to 16 carbon atoms. Another embodiment of the invention comprises the mixture of the above blendstock with petroleum derived materials in a jet fuel product. Another embodiment of the invention comprises a mixture of the renewable fuel blendstock with petroleum-derived materials such as jet fuel wherein the renewable fuel blendstock comprises from 0.1 to 80%, or 3 to 70%, or 5-60% by volume of the jet fuel and the balance of the mixture comprises petroleum-derived jet fuel.

### BRIEF DESCRIPTION OF THE DRAWINGS

FIGS. 1, 2, 3 and 4 are block flow illustrations of various features of the inventive process.

An embodiment of the present improved process comprises steps of:
a. feeding biomass, such as, for example, that provided from renewable sources of organic materials, catalyst composition, such as comprising one or more crystalline molecular sieves, for example, those characterized by a SAR greater than 12 and a CI from 1 to 12, and transport fluid to a catalytic pyrolysis process fluidized bed reactor maintained at reaction conditions, for example, a temperature from 300 to 1000° C. and pressure from 0.1 to 1.5 MPa, to manufacture a raw fluid product stream,
b. feeding the raw fluid product stream of step a) to a solids separation and stripping system to produce separated solids and a fluid product stream,
c. feeding the fluid product stream of step b) to a fractionation system in order to recover a fraction such as one boiling at 180° C. to 350° C. preferably such as one boiling at 180° C. to 320° C., much preferably such as on boiling at 200 to 310° C.
d. hydrogenating at least a portion of the fraction boiling between 180° C. and 350° C. of step c) at hydrogenating conditions to produce a hydrogenated fraction, and
e. recovering chemicals comprising tetralins, decalins, or substituted tetralins or decalins, or some combination thereof, wherein the number of carbon atoms in the products comprises from 10 to 16 carbon atoms, in a product recovery system.

### DETAILS OF INVENTIVE PROCESSES

### Catalytic Pyrolysis Description

Several embodiments of the invention are depicted in FIG. 1, wherein stream 1 is derived from the Bio-TCat™ process. Examples of apparatus and process conditions suitable for the Bio-TCat™ process are described in U.S. Pat. Nos. 8,277,643, 8,864,984, 9,169,442, 9,790,179, 10,370,601, 10,767,127; and 10,822,562, each incorporated herein by reference. Conditions for Bio-TCat™ conversion of biomass may include one or a combination of the following features (which are not intended to limit the broader aspects of the invention): biomass treatment; a catalyst composition; that catalyst composition optionally comprising a metal; a fluidized bed, circulating bed, moving bed, or riser reactor; a fluidizing fluid; an operating temperature in the range of 300° C. to 1000° C., or 450° C. to 800° C., or 500° C. to 650° C., and a pressure in the range of 0.1 to 3.0 MPa (1 to 30 atm); and a solid catalyst/biomass mass ratio of from 0.1 to 40, or 2 to 20, or 3 to 10. Solid biomass may be fed to the reactor in a continuous or intermittent fashion. Solid catalyst may be regenerated in an oxidative process and in part returned to the reactor. Solid catalyst may be removed from the reactor, stripped with steam to displace organic materials and reactive gases, and then regenerated in a fluid bed catalyst regenerator by treatment with an oxygen containing gas, and in part returned to the reactor. To reduce the fraction of non-aromatic components in the products, and thereby benefit downstream separation and conversion technologies, the reaction severity in the Bio-TCat™reactor can be increased. Methods to achieve greater reaction severity include higher reaction temperature, higher catalyst activity which can be achieved by higher fresh catalyst makeup and spent catalyst removal rates, or by changes to the catalyst (e.g. higher zeolite content, lower silica/alumina ratio, greater macro and meso-porosity, etc), higher pressure, or longer residence time.

Biomass may not be available in a convenient form for processing in the fluid bed reactor of the Bio-TCat™ process. While solid biomass is the preferred feed, the solid biomass may comprise portions of liquids at ambient conditions. Solid biomass may be treated in any of a number of ways to make it more suitable for processing including cutting, chopping, chipping, shredding, pulverizing, grinding, sizing, drying, roasting, torrefying, washing, extracting, or some combination of these in any order to achieve the desired properties of the biomass feed as to size, moisture, sulfur and nitrogen impurities content, density, and metals content. Procedures to inhibit biomass clumping and agglomeration may be employed.

Following conversion in the fluid bed reactor, the products of the Bio-TCat™ process are recovered by a combination of solids separation, hydrocarbon quenching or cooling, gas-liquid separation, compression cooling, gas-liquid absorption, condensation of condensable compounds, or other methods known in the art, to produce a mixture of C₄⁺ hydrocarbons including species having boiling points above those of gasoline or on-road diesel fuels. Distillation can be used to separate out the desired cut by boiling point range. The desired product cut can then be subject to hydrotreating to remove heteroatoms such as O, N, or S, and saturate olefins, and provide a first liquid stream.

In some embodiments the product mixture from the catalytic pyrolysis process comprises compounds from among 2-methyl naphthalene, naphthalene, indene, 1,2,4-trimethyl benzene, 1,5-dimethyl naphthalene, 2-methyl indane, 1-methylanthracene,-methyl styrene, 5-methyl indane indane 3-ethyl toluene, 1-methyl indene, 2-phenyl-naphthalene, anthracene, 2,3-dimethyl indene, 1-benzyl naphthalene, 2,6-dimethyl naphthalene, 4-ethyl toluene, 1,3-dimethyl indene, 9h-fluorene, 2-methyl-biphenyl, 1-methyl-4-propylbenzene, 1-methyl naphthalene, 1,7-dimethyl naphthalene, 9h-fluorene, 1-methyl-4-methyl indene, 2-(1-methylethyl)-naphthalene, 1h-indene 1-ethyl-2,3-dihydro, 1-phenylcyclohexene, n-propyl benzene, 11h-benzo-[b]-fluorene, 1,4-diethyl cyclohexane, 1,2,3-trimethyl benzene, 1-ethenyl-4-ethylbenzene, 1-methyl indane, 2,3,5-trimethylnaphthalene, 3-methyl-1,1-biphenyl, propadienylcyclohexane, trimethyl azulene, phenanthrene, 2-ethyl naphthalene, fluorene, 1,2-dihydro naphthalene, 2-methyl indene, 1,2-dihydro 4-methylnaphthalene, 2,6-dimethyl phenanthrene, 1-methyl-7-isopropyl phenanthrene, 1,2-dihydro 3-methylnaphthalene, 1,4,6-trimethylnaphthalene, 2-phenanthrenyl, 1,2,3,4-tetrahydro-4-methyl indane, 1,2,3,4-tetrahydronaphthalene, 2,2-dimethyl indane, 1,4-dihydro naphthalene, 1-methyl-4-(propan-2-yl)benzene, 1 4-dimethyl-2-phenyl naphthalene, and oxygenates 3-phenanthrol, 1h-indenol, 1-naphthalenol (1-naphthol), 2-methyl-1-naphthol, 2-methyl benzofuran, 2-acetyl-5-norbornene, dibenzofuran, 2-naphthalenol, 7-methyl-1-naphthol, 5-isopropyl-2-methylphenol, 2,3-dihydro-1h-inden-5-ol, 5,8-dihydro-1-naphthalenol, 5-methoxyindan, 1,7,7-trimethylbicyclo[2.2.1]heptan-2-one, 2-(2-propynyl)-phenol, (2E)-3-phenylprop-2-enal (cinnamaldehyde), 2,3-dimethyl benzofuran, 2,3,6-trimethyl-phenol, and combinations thereof.

### Catalysts for Catalytic Pyrolysis

For catalytic pyrolysis, useful catalysts include those containing internal porosity selected according to pore size (e.g., mesoporous and pore sizes typically associated with zeolites), e.g., average pore sizes of less than 10 nm (1 nm equals 10 Angstroms, Å), less than 5 nm, less than 2 nm, less than 1 nm, less than 0.5 nm, or smaller. In some embodiments, catalysts with average pore sizes of from 0.5 nm to 10 nm may be used. In some embodiments, catalysts with average pore sizes of between 0.5 nm and 0.65 nm, or between 0.59 nm and 0.63 nm may be used. In some cases, catalysts with average pore sizes of between 0.7 nm and 0.8 nm, or between 0.72 nm and 0.78 nm may be used.

The catalyst composition particularly advantageous in the catalytic pyrolysis fluidized bed reactor of the present invention comprises a crystalline molecular sieve characterized by a silica to alumina ratio (SAR) greater than 12 and a Constraint Index (CI) from 1 to 12. Non-limiting examples of these crystalline molecular sieves are those having the structure of ZSM-5, ZSM-11, ZSM-12, ZSM-22, ZSM-23, ZSM-35, ZSM-48, ZSM-50 or combinations thereof. As an embodiment, the catalyst composition comprises a crystalline molecular sieve characterized by an SAR from greater than 12 to 240 and a CI from 5 to 10, such as, for example, molecular sieves having the structure of ZSM-5, ZSM-11, ZSM-22, ZSM-23 or combinations thereof. The method by which CI is determined is described more fully in U.S. Pat. No. 4,029,716, incorporated by reference for details of the method.

Without limitation, some such and other catalysts can be selected from naturally-occurring zeolites, synthetic zeolites and combinations thereof. In certain embodiments, the catalyst may be a ZSM-5 zeolite catalyst, as would be understood as those skilled in the art. Optionally, such a catalyst can comprise acidic sites. Other types of zeolite catalysts include ferrierite, zeolite Y, zeolite beta, mordenite, MCM-22, ZSM-23, ZSM-57, SUZ-4, EU-1, ZSM-11, (S)AIPO-31, SSZ-23, among others. In other embodiments, non-zeolite catalysts may be used; for example, WOx/ZrO2, aluminum phosphates, etc. In some embodiments, the catalyst may comprise a metal and/or a metal oxide chosen from among nickel, palladium, platinum, titanium, vanadium, chromium, manganese, iron, cobalt, zinc, copper, gallium, the rare earth elements, i.e., elements 57-71, cerium, zirconium, and/or any of their oxides, or some combination thereof. In addition, in some cases, properties of the catalysts (e.g., pore structure, type and/or number of acid sites, etc.) may be chosen to selectively produce a desired product.

The molecular sieve for use herein or the catalyst composition comprising same may be thermally treated at high temperatures. This thermal treatment is generally performed by heating at a temperature of at least 370° C. for a least 1 minute and generally not longer than 20 hours (typically in an oxygen containing atmosphere, preferably air). While sub atmospheric pressure can be employed for the thermal treatment, atmospheric pressure is desired for reasons of convenience. The thermal treatment can be performed at a temperature up to about 925° C. The thermally treated product is particularly useful in the present process.

For the catalyst composition useful in this invention, the suitable molecular sieve may be employed in combination with a support or binder material such as, for example, a porous inorganic oxide support or a clay binder. Non-limiting examples of such binder materials include alumina, zirconia, silica, magnesia, thoria, titania, boria and combinations thereof, generally in the form of dried inorganic oxide gels and gelatinous precipitates. Suitable clay materials include, by way of example, bentonite, kieselguhr and combinations thereof. The relative proportion of suitable crystalline molecular sieve of the total catalyst composition may vary widely with the molecular sieve content ranging from 30 to 90 percent by weight and more usually in the range of 40 to 70 percent by weight of the composition. The catalyst composition may be in the form of an extrudate, beads or fluidizable microspheres.

The molecular sieve for use herein or the catalyst composition comprising it may have original cations replaced, in accordance with techniques well known in the art, at least in part, by ion exchange with hydrogen or hydrogen precursor cations and/or non-noble metal ions of Group VIII of the Periodic Table, i.e. nickel, iron, or cobalt, or some combination thereof.

### Fractionation

The effluent from the catalytic pyrolysis 1 is cooled in heat exchanger 150, optionally generating steam, and then fed to a main fractionation column 200. A portion of stream 4 containing naphthalene and tars is recycled to the fractionation column 200 and another portion is taken from the bottom of the fractionation column and sent to an additional distillation column 400 for efficient separation of 3 ring species in stream 13 from the naphthalene rich stream 12 that may optionally contain xylenols to reach the ending boiling point target of no greater than 350° C., or preferably no greater than 320° C., or much preferably no greater than 310° C. as described above.

Ending boiling point is fixed no more than 310-320° C., preferably 300-310° C. to minimize the presence of compounds such as phenanthrene, anthracene, and related compounds.

After removal of the materials that boil at 180° C. and lower, the mixture may comprise at least 25, or at least 35, or at least 40, or from 25 to 90, or from 35 to 80, or from 40 to 75 wt % sum of naphthalene, substituted naphthalenes, naphthalenols, methyl naphthalenols, and naphthalene diols, and at least 3, or at least 5, or at least 6, or from 3 to 15, or from 5 to 10, or from 6 to 8 weight % xylenols, and less than 15, or less than 10, or less than 5, or from 0.01 to 20, or from 1 to 15, or from 5 to 13 weight % the sum of phenanthrene, anthracene, and other materials.

Optionally, at least a portion of streams 3 or 13, or at least a portion of the fraction remaining after the fraction boiling below 310, or 320, or 350° C. recovered in fractionation step has been removed, or some combination thereof can be hydrocracked in a hydrocracking process.

FIGS. 2 and 3 are conceptual block flow diagrams that show the hydrogenation of the naphthalene-rich stream to cycloalkanes using hydrogen to produce a stream containing less than 5%, or less than 3%, or less than 1% of the naphthalenic species. Design of the hydrogenation units are easily done by those familiar with the art of hydrogenation of petrochemical naphthalenic species. The reactor can incorporate features to control the exotherm of hydrogenation typically practiced by those skilled in the art. These features can be chosen from among: 1) recycle of cooled hydrogen 2) dilution of the feed to limit the percentage of hydrogen added to the total mass of feed, 3) introduction of “quench fluid” at various points in the reactor, whereby the heat of vaporization of the liquid is used to temper the exotherm, or some combination thereof. Such quench liquid is typically derived from the product stream, either before or after removal of more volatile components.

In FIG. 2 one embodiment of the naphthalene-rich stream hydrogenation and purification process is presented. A naphthalene-rich stream, optionally containing xylenols, 12, such as that produced from biomass by the processes in FIG. 1, or similar processes, is passed to a hydrogenation reactor 500 along with hydrogen 22. In the hydrogenation reactor the naphthalene-rich stream is hydrogenated to tetralins, decalins, other naphthenes, and similar cycloalkane materials, which mixture 23 is passed to purification column 600. Any xylenols present will be hydrogenated to benzene, toluene, xylenes, and naphthenes in this reactor as well. In purification column 600 the light materials 24 are passed to a decanter/reflux drum 700 where the xylenes are recovered in stream 25, a portion of the mixture 27 is returned to the separation column, and a water fraction 26 is separated. Stream 27 typically comprises tetralins, decalins, other napthenes, as well as some xylenes, and some water. A purified cycloalkane containing stream 28 is separated and recovered as product. A slipstream of the cycloalkanes 28 is returned to the separation column. Returning some of the heavier materials to column 600 can improve the efficiency and yield. The naphthalene rich stream 12 may comprise at least 25, or at least 35, or at least 40, or from 25 to 90, or from 35 to 80, or from 40 to 75 wt % sum of naphthalene, substituted naphthalenes, naphthalenols, methyl naphthalenols, and naphthalene diols, and at least 3, or at least 5, or at least 6, or from 3 to 15, or from 5 to 10, or from 6 to 8 weight % xylenols, and less than 15, or less than 10, or less than 5, or from 0.01 to 20, or from 1 to 15, or from 5 to 13 weight % the sum of phenanthrene, anthracene, and other materials.

In FIG. 2, the hydrogenation is done in one step, and the resulting product is fed to a distillation column to remove water derived from hydrogenation of oxygen-containing two-ring species and other compounds, and to remove xylenes resulting from the deoxygenation of xylenols, which can be fed to the purification scheme as described in US2020/0165527. The bottoms from the distillation column 28 can then be sold as a jet fuel additive or blendstock that comprises over 90% biomass derived content.

In FIG. 3 another embodiment of the inventive process is presented that includes a second hydrogenation step. A naphthalene-rich stream 12, such as that produced from biomass by the process in FIG. 1, or other processes, is passed to a hydrogenation reactor 500 along with hydrogen 22. In the hydrogenation reactor the naphthalene-rich stream is hydrogenated to tetralins, decalins, other naphthenes, and similar materials, which mixture 23 is passed to purification column 600. Any xylenols present will be hydrogenated to a mixture of xylenes, toluene, benzene, and naphthenes in this reactor 500 as well. In purification column 600 the light materials 24 are passed to a decanter/reflux drum 700 where the xylenes are recovered in stream 25; a portion of the mixture 27 is returned to the separation column, and a water fraction 26 is separated. A purified, partially hydrogenated cycloalkanes containing stream 28 is separated from column 600 and sent to a second hydrogenation reactor 800 while a slipstream of the cycloalkanes stream 28 is returned to the separation column. Hydrogen 29 is also sent to the second hydrogenation reactor 800 where the products are further hydrogenated, and the hydrogenated product 30 is recovered.

Optionally, in FIG. 3, the hydrogenation in 500 can be divided into two steps, whereby the hydrogenation reactor 500 effectively comprises a hydrogenation to produce a partially hydrogenated stream by operation at lower pressure to partially hydrogenate aromatic rings and reduce xylenols to benzene, toluene, and xylenes, and reduce naphthalenes to naphthenes, and a second reactor (not shown) that further hydrogenates aromatics by operation at higher pressure, and hydrogenation reactor 800 is eliminated. In this case the first hydrogenation can be operated within the range of 2.0 to 7.0 MPa with a CoMo containing catalyst. An optional distillation can be inserted after the first hydrogenation step of 500 to remove the water of reaction as well as the xylenes. The second hydrogenation process in 500 (not shown) completes the hydrogenation of the aromatics to produce cycloalkanes, and can use a noble metal catalyst such as one containing Pd, or Pt, or a combination of the two. The second hydrogenation can be operated at a similar, but higher, pressure as the first hydrogenation, within the range from 2.0 to 8.0 MPa. This combination of low pressure hydrogenation in 500, optional distillation (not shown), and higher pressure hydrogenation will produce a product that would not need any additional purification. An alternative embodiment is to conduct the distillation after the second hydrogenation step in 500.

Another embodiment of the invention is presented in FIG. 4 in which the tetralins or decalins or both are cracked or hydrocracked to produce a stream comprising alkylated benzenes, or alkylated tetralins, or some combination of these. A naphthalene-rich stream 12, such as that produced from biomass by the process in any of FIG. 1, or other processes, is passed to a hydrogenation reactor 500 along with hydrogen 22. In the hydrogenation reactor the naphthalene-rich stream is hydrogenated to tetralins, decalins, other naphthenes, and similar materials, which mixture 23 is passed to purification column 600. Any xylenols present will be hydrogenated to benzene, toluene, and xylenes in the hydrogenation reactor 500 as well. In purification column 600 the light materials 24 are passed to a decanter/reflux drum 700 where the xylenes are recovered in stream 25; a portion of the mixture 27 is returned to the separation column, and a water fraction 26 is separated. A purified, partially hydrogenated cycloalkanes containing stream 28 is optionally separated from column 600 and sent to an optional second hydrogenation reactor 800 while a slipstream of the cycloalkanes stream 28 is returned to the separation column. Hydrogen 29 is also sent to the second optional hydrogenation reactor 800 where the products are further hydrogenated, and the hydrogenated product 30 is recovered. Either stream 28 or stream 30 is cracked or hydrocracked, i.e. with or without hydrogen, in unit 900 to open the paraffinic cyclic portions of the molecules to produce alkylated benzenes, alkylated cyclohexanes, or both as stream 32, and a fraction of gases that may include hydrogen, methane, ethane, ethylene, propane, propylene, butanes, butenes, or a mixture of these in stream 31. The product stream 32 comprises a jet fuel blending stream that more closely matches the specifications of jet fuel A or A-1

In any of the cases above, if the hydrogen is derived from the catalytic pyrolysis of biomass, the biomass derived content of the fuel produced can approach 100%. In each of the embodiments presented in FIGS. 3 through 7, a portion of the unreacted hydrogen is optionally collected from the overheads of the hydrogenation reactor 500, or hydrogenation reactor 800, or separation column 600, or reactor 900, or some combination thereof, and recycled to the one or more hydrogenation reactor(s).

### Hydrogenation

The hydrogenation of the naphthalene-rich fraction may be conducted by contacting the liquid with a H₂ containing gas at a pressure from 4 MPa to 15 MPa (40 to 150 atm), preferably 6 to 12 MPa (60 to 120 atm) at a temperature from 280 to 400° C., preferably from 320 to 350° C., in the presence of a solid catalyst. Solid catalysts useful for the hydrogenation process include Ni/Mo, Co/Mo, optionally containing Fe, Cu, Zn, Ag, Pt, Pd, Ru, Rh, Ir, Mo, W, or combinations thereof, deposited on oxide supports including oxides of Al, Si, Ti, Zr, Th, Mg, Ca, or some combination of these, either as crystalline solids or as amorphous mixtures. The hydrogenation can be carried out in a fixed bed, trickle bed, catalytic distillation reactor, multi-tubular reactor, or fluid bed reactor, with counter- or co-current flow of feed and hydrogen.

Jet fuel is a complex mixture of many hundreds of individual chemicals, made from various blendstocks that are produced in a refinery or produced elsewhere and blended either at the refinery or at the distribution terminal. To meet technical, regulatory, and commercial requirements, the jet fuel finished blend must meet several constraints including flash point, smoke point, autoignition temperature, density, limits on freezing point (<−47 C), aromatics content (<25 wt %), naphthalene content (<3.0 wt %), sulfur (<0.3 wt %), specific energy (>42.8 MJ/kg), boiling range (<10 wt % below 205° C., balance between 205 and 300° C.), etc. Therefore, it is possible that more than one combination and proportion of various blendstocks can result in a finished jet fuel meeting all of the constraints and requirements.

### Blendstocks

An embodiment of the present invention is a renewable jet fuel blendstock that comprises a mixture of naphthenes, aromatics, and paraffins produced by the steps of pyrolyzing and catalytically reacting biomass in a fluid bed reactor, quenching the product mixture by admixture with a hydrocarbon liquid or cooling, separating vapors from the quench mixture, condensing and separating an organic phase from the vapors, separating the organic phase into a higher boiling and a lower boiling fraction, hydrogenating at least a portion of the higher boiling fraction, and separating and recovering a renewable jet fuel blendstock product fraction boiling between 180° C. and 300° C.

In one embodiment the renewable jet fuel blendstock mixture may comprise from 30 to 98, or from 50 to 97, or from 65 to 95 wt % naphthenes, from 3 to 50 wt % tetralins, no more than 30, or no more than 20, or no more than 10, or no more than 5, or from 1 to 30, or from 2 to 20, or from 2 to 15, or from 2 to 10 wt % naphthalenes and alkyl naphthalenes, no more than 0.1, or no more than 1, or no more than 2, or no more than 3, or no more than 5, or from 0.1 to 5, or from 0.5 to 3, or from 0.5 to 2 wt % the sum of acenaphthenes, acenaphthylenes, fluorenes, phenanthrenes, and anthracenes as determined by Mass spectroscopy.

In another embodiment the renewable jet fuel blendstock may comprise at least 30, or at least 50 or at least 65, or at least 90, or from 30 to 95, or from 50 to 95, or from 65 to 95 wt % saturates, no more than 55, or 40, or 30 or 7, or from 2 to 75, or from 3 to 40, or from 4 to 26 wt % monoaromatics, no more than 12, or 9, or 5, or 3, or from 0.5 to 20, or from 1 to 12, or from 2 to 7 wt % diaromatics, and no more than 0.5, or 0.3, or 0.2, or from 0.01 to 0.5, or from 0.1 to 0.3 wt % triaromatics.

Other embodiments of the present invention are renewable fuel blendstocks or processing feedstocks that comprise a mixture of aromatics and naphthenes produced by the steps of: pyrolyzing and catalytically reacting biomass in a fluid bed reactor, quenching the product mixture by admixture with a hydrocarbon liquid or cooling, separating vapors from the quench mixture, condensing and separating an organic phase from the vapors, separating the organic phase into a higher boiling and a lower boiling fraction, hydrogenating at least a portion of the higher boiling fraction, recovering condensable products therefrom, and separating the condensed products into a fraction boiling below 180° C., a fraction boiling between 180° C. and 300° C., and a fraction boiling above about 300° C. The fraction boiling between 180° C. and 300° C. may comprise at least 75, or at least 85, or at least 90, or from 75 to 99.9, or from 85 to 99 wt % naphthenes, and less than 20%, or less than 15%, or less than 10, or from 1 to 20, or from 5 to 10 wt % the sum of benzene, toluene, and xylenes, and less than 3, or less than 2, or less than 1, or from 0.001 to 3, or 0.01 to 2 wt % of the naphthalenes, and less than 0.4%, or less than 0.1 weight %, or less than 100 ppm, or less than 25 ppm, or from 1 to 1000 ppm, or from 2 to 25 ppm olefins by weight, and less than 10, or less than 5, or less than 2 ppm, or from 0.01 to 10, or from 0.01 to 5 ppm by weight 3-ring aromatics, and less than 0.4%, or less than 0.1 weight %, or less than 100 ppm, or less than 25 ppm, or from 1 to 1000 ppm, or from 2 to 25 ppm olefins by weight, and less than 10, or less than 5, or less than 2 ppm, or from 0.01 to 10, or from 0.01 to 5 ppm by weight sulfur, and less than 10, or less than 5, or less than 2, or from 0.01 to 10, or from 0.01 to 5 ppm by weight nitrogen, and less than 1%, or less than 0.1%, or less than 0.01 weight %, or less than 100 ppm, or less than 10 ppm, or less than 1 ppm, or from 0.01 to 1000 ppm, or from 0.01 to 10 ppm oxygen by weight. The lower boiling fraction may comprise at least 50%, or at least 60%, or at least 65 volume % the sum of benzene, toluene, and xylenes, and less than 15, or less than 10, or less than 6 volume % C9 and higher aromatics, and less than 2, or less than 1, or less than 0.5 volume % paraffins, and less than 0.4, or less than 0.1 weight %, or less than 100 ppm, or less than 25 ppm olefins by weight, and less than 10, or less than 5, or less than 2 ppm by weight sulfur, and less than 10, or less than 5, or less than 2 ppm by weight nitrogen, and less than 1, or less than 0.1, or less than 0.01 weight %, or less than 100 ppm, or less than 10 ppm, or less than 1 ppm oxygen by weight.

### Fuel Blends

Another embodiment of the invention comprises a mixture of the renewable fraction of the inventive process boiling between 180° C. and 300° C. with petroleum derived materials such as jet fuel. In some embodiments the renewable fraction of the product of the invention boiling between 180° C. and 300° C. comprises from 0.1 to 90, or 1 to 70, or 1 to 50, or 1 to 20, or 0.1 to 10 volume %, or at least 0.1, or at least 5, or at least 10, or at least 20 volume %, and the balance of the mixture comprises conventional petroleum-derived jet fuel.

In one embodiment, a fuel blending system can be used to combine a petroleum-derived jet fuel with at least a portion of the renewable biomass derived blendstocks of the inventive process to produce renewable jet fuel compositions. The renewable jet fuel blend composition can comprise petroleum-derived jet fuel in an amount of at least 80, or 85, or 90, or 95 volume %, and/or up to 96, or 98, or 99, or 99.5, volume %; or from 80 to 99.5, or from 90 to 98 volume %, and the renewable blendstock fraction in an amount of at least 0.1, or 0.5, or 1, or 5, volume %, or no more than 20, or 15, or 10, or 5, volume %, or from 0.1 to 20, or from 1 to 10 volume %.

In a further aspect, the invention provides a jet fuel blend that comprises from 0.1 to 90, or 1 to 70, or 1 to 50, or 1 to 20, or 0.1 to 10 volume %, or at least 0.1, or at least 5, or at least 10, or at least 20 volume %, of the renewable fuel blendstock described in any of the preceding claims and the balance of the jet or diesel fuel blend comprises petroleum-derived jet or diesel fuel.

The renewable jet fuel compositions may have sulfur contents of less than 0.3, or less than 0.2, or less than 0.1, or from 0.01 to 0.3, or from 0.1 to 0.25 wt %, or aromatics contents of less than 60, or less than 50, or less than 25, or less than 20 or less than 15 wt %, or from 5 to 60, or from 5 to 50, or from 10 to 60, or from 20 to 60, or from 20 to 40, or from 20 to 30 wt %.

In a further aspect, the invention provides a renewable jet fuel blendstock mixture comprising from 30 to 98, or from 50 to 97, or from 65 to 95 wt % naphthenes, from 3 to 50 wt % tetralins, no more than 30, or no more than 20, or no more than 10, or no more than 5, or from 1 to 30, or from 2 to 20, or from 2 to 15, or from 2 to 10 wt % naphthalenes and alkyl naphthalenes, no more than 0.1, or no more than 1, or no more than 2, or no more than 3, or no more than 5, or from 0.1 to 5, or from 0.5 to 3, or from 0.5 to 2 wt % the sum of acenaphthenes, acenaphthylenes, fluorenes, phenanthrenes, and anthracenes as determined by Mass spectroscopy.

The invention can be further characterized by one or any combination of the following features: comprising petroleum-derived jet fuel in an amount of at least 80, or 85, or 90, or 95 volume %, and/or up to 96, or 98, or 99, or 99.5, volume %; or from 80 to 99.5, or from 90 to 98 volume %, and the renewable blendstock fraction in an amount of at least 0.1, or 0.5, or 1, or 5, volume %, or no more than 20, or 15, or 10, or 5, volume %, or from 0.1 to 20, or from 1 to 10 volume %; sulfur contents of less than 0.3, or less than 0.2, or less than 0.1, or from 0.01 to 0.3, or from 0.1 to 0.25 wt %, or aromatics contents of less than 60, or less than 50, or less than 25, or less than 20 or less than 15 wt %, or from 5 to 60, or from 5 to 50, or from 10 to 60, or from 20 to 60, or from 20 to 40, or from 20 to 30 wt %, or some combination thereof.

In a further aspect, the invention provides a renewable distillate fuel blendstock comprising at least 30, or at least 50 or at least 65, or at least 90, or from 30 to 95, or from 50 to 95, or from 65 to 95 wt % saturates, no more than 55, or 40, or 30 or 7, or from 2 to 75, or from 3 to 40, or from 4 to 26 wt % monoaromatics, no more than 12, or 9, or 5, or 3, or from 0.5 to 20, or from 1 to 12, or from 2 to 7 wt % diaromatics, and no more than 0.5, or 0.3, or 0.2, or from 0.01 to 0.5, or from 0.1 to 0.3 wt % triaromatics as determined by Mass spectroscopy.

In another aspect, the invention provides a renewable distillate fuel blendstock comprising at least 75, or at least 85, or at least 90, or from 75 to 99.9, or from 85 to 99 wt % naphthenes, and less than 20%, or less than 15%, or less than 10, or from 1 to 20, or from 5 to 10 wt % the sum of benzene, toluene, and xylenes, and less than 3, or less than 2, or less than 1, or from 0.001 to 3, or 0.01 to 2 wt % of the naphthalenes, and less than 0.4%, or less than 0.1 weight %, or less than 100 ppm, or less than 25 ppm, or from 1 to 1000 ppm, or from 2 to 25 ppm olefins by weight, and less than 10, or less than 5, or less than 2 ppm, or from 0.01 to 10, or from 0.01 to 5 ppm by weight 3-ring aromatics, and less than 0.4%, or less than 0.1 weight %, or less than 100 ppm, or less than 25 ppm, or from 1 to 1000 ppm, or from 2 to 25 ppm olefins by weight, and less than 10, or less than 5, or less than 2 ppm, or from 0.01 to 10, or from 0.01 to 5 ppm by weight sulfur, and less than 10, or less than 5, or less than 2, or from 0.01 to 10, or from 0.01 to 5 ppm by weight nitrogen, and less than 1, or less than 0.1, or less than 0.01 weight %, or less than 100 ppm, or less than 10 ppm, or less than 1 ppm, or from 0.01 to 1000 ppm, or from 0.01 to 10 ppm oxygen by weight.

The following Examples demonstrate the present invention and its capability for use. The invention is capable of other and different embodiments, and its several details are capable of modifications in various apparent respects, without departing from the spirit and scope of the invention. Accordingly, the Examples are to be regarded as illustrative in nature and not as restrictive. All parts and percentages are by weight and all temperatures are set forth uncorrected in degrees Celsius, unless otherwise indicated.

The entire disclosures of all applications, patents and publications, test procedures, priority documents, articles, publications, manuals, and other documents cited herein and copending U.S. Provisional Application (Attorney Docket No. PET-3515-V01) are incorporated by reference herein for all jurisdictions in which such incorporation is permitted.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

### Examples 1 Through 3

Several samples of the organic liquid products obtained from operation of a catalytic pyrolysis Bio-TCat pilot plant (T-Cat8) with loblolly pine as the feedstock were distilled to obtain various cuts based on the boiling ranges 204+, 204-320, 204-300, all ° C., where 204+ means all the materials that boil at or above 204° where ‘+’ indicates all material boiling above this temperature are included in the cut.

The compositions of the various cuts determined by GC-MS are summarized in Table 1.

TABLE 1
Compositions of various fractions of material recovered
from the separation of the products of a catalytic
pyrolysis process. All are weight %.

| | Examples | | |
|---|---|---|---|
| | 1 | 2 | 3 |
| Boiling Range, ° C. | 204-300 | 204-320 | 204+ |
| Phenol | 0.0 | 0.1 | 0.0 |
| MethylPhenol | 2.3 | 4.4 | 3.4 |
| DimethylPhenol | 6.1 | 6.1 | 7.1 |
| EthylPhenol | 0.2 | 0.2 | 0.1 |
| C3-Phenol | 1.9 | 1.5 | 0.2 |
| C4-Phenol | 0.3 | 0.3 | — |
| Benzofuran | 0.0 | 0.0 | — |
| MethylBenzofuran | 0.1 | 0.5 | — |
| C2-Benzofuran | 0.4 | 0.4 | — |
| Naphthalene | 8.2 | 12.2 | 8.6 |
| MethylNaphthalene | 31.8 | 25.3 | 22.4 |
| C2-Naphthalene | 16.2 | 13.0 | 12.9 |
| C3-Naphthalene | 6.2 | 5.7 | 1.9 |
| Naphthalenol | 4.3 | 4.5 | 5.8 |
| MethylNaphthalenol | 0.7 | 3.5 | 4.9 |
| C2-Naphthalenol | 0.0 | 0.9 | — |
| Anthracene | — | — | 0.5 |

### Examples 4 Through 7

The 204-300° C. cut was selected as the feed for producing renewable jet fuel; analytical results of the 204-300° C. cut and the products are in Table 3.

Hydrogenation experiments were carried out on the selected feed in a 33 cc downflow packed bed reactor unit with independent feedstock and product recovery sections. The catalyst was a commercial NiMo/Al₂O₃ catalyst that was fully sulfided in situ before initiating the hydrogenation. Reactor effluents are depressurized and send to a H2 stripper. The gas fraction is recovered at the stripper top and analyzed through on-line gas chromatography. The liquid fraction is recovered from the stripper bottom and analyzed off-line. The process is allowed to line-out to a steady state before commencing product collection and analysis.

Four hydrogenation experiments were conducted and the experimental parameters for the tests are presented in Table 2. A comparison of the product characterization data to that of 10 Jet A-1 specifications is presented in Table 3. Detailed analytical data for the hydrogenation products are presented in Table 4.

TABLE 2
Parameters of Hydrogenation Examples 1 through 4.

| | | | | H2/feed | H2/feed | Catalyst |
|---|---|---|---|---|---|---|
| | P | T | LHSV | inlet | outlet | age |
| | (barg) | (° C.) | (h − 1) | (NL/L) | (NL/L) | (hours) |
| Example 4 | 120 | 330 | 1.0 | 2000 | 1229 | 212 |
| Example 5 | 90 | 330 | 1.0 | 2000 | 1253 | 788 |
| Example 6 | 105 | 330 | 1.0 | 2000 | 1328 | 980 |
| Example 7 | 105 | 340 | 1.0 | 2000 | 1291 | 1052 |

TABLE 3
Summary of Results of Hydrogenation Experiments

| Main Jet fuel | | Jet A-1 | Feed | | | | |
|---|---|---|---|---|---|---|---|
| specifications | units | spec. | 204-300° C. | Example 4 | Example 5 | Example 6 | Example 7 |
| Temperature | C. | — | — | 330 | 330 | 330 | 340 |
| Pressure | barg | — | — | 120 | 90 | 105 | 105 |
| Density at | g/cm3 | 0.775-0.840 | 1.0265 | 0.8660 | 0.8826 | 0.8999 | 0.8718 |
| 15° C. | | | | | | | |
| Aromatics | vol % | <25 | ≈100 | 2.4 | 25.7 | 39.0 | 14.6 |
| Naphthalenes | vol % | <3.0 | ≈53 | 1.0 | 5.0 | 6.9 | 3.5 |
| Freezing point | ° C. | <−47 | — | <−80 | <−80 | <−80 | <−80 |
| Sulfur | wt % | <0.3 | 0.0078 | 0.00012 | 0.00004 | 0.00004 | 0.00008 |
| Flash point | ° C. | >38 | — | 46.5 | — | — | — |
| 10 wt % | ° C. | <205 | 203 | 176 | 156 | 181 | 150 |
| recovered at | | | | | | | |
| End point (% | ° C. | <300 | 303 (99%) | 382 (99%) | 360 (99%) | 361 (99%) | 361 (99%) |
| recovered) | | | | 307 (97%) | 280 (97%) | 270 (97%) | 278 (97%) |

TABLE 4
Detailed Results of Hydrogenation Examples 1 through 4

| | | | | | |
|---|---|---|---|---|---|
| Units | Feed | Example 4 | Example 5 | Example 6 | Example 7 |

| | | | | | |
|---|---|---|---|---|---|
| Temperature | ° C. | 330 | 330 | 330 | 340 |
| Pressure | bar | 120 | 105 | 90 | 105 |
| Yield (of feed) | wt % | 98.98 | 94.78 | 97.96 | 94.49 |

Simulated Distillation

| | | | | | | |
|---|---|---|---|---|---|---|
| Initial Boiling Pt | | 186.6 | 103.7 | 101.9 | 103.2 | 99.1 |
| 5 wt % | ° C. | 202.9 | 139.3 | 121.3 | 144.8 | 117 |
| 10 wt % | ° C. | 207.8 | 176 | 155.7 | 181.4 | 150.3 |
| 50 wt % | ° C. | 230.3 | 199.9 | 202.1 | 206.7 | 196.7 |
| 90 wt % | ° C. | 269.5 | 230.8 | 235.5 | 237.9 | 230.6 |
| 95 wt % | ° C. | 281.9 | 255.4 | 252.1 | 254.9 | 248.3 |
| Final BP | ° C. | 312.2 | 446.1 | 386.6 | 382.9 | 393.1 |

Global Analyses

| | | | | | | |
|---|---|---|---|---|---|---|
| Density at 15° C. | g/cm3 | 1.0265 | 0.8660 | 0.8826 | 0.8999 | 0.8718 |
| Water content (Karl | mg/kg | | 30 | 11 | 19 | 19 |
| Fisher) | | | | | | |
| Freezing point | ° C. | | <−80 | <−80 | <−80 | <−80 |
| Flash point | ° C. | | 46.5 | — | — | — |

Aromatics

| | | | | | |
|---|---|---|---|---|---|
| C remaining in aromatics | % C | 2.3 | 15.6 | 21.2 | 10.3 |

Elemental Analysis

| | | | | | | |
|---|---|---|---|---|---|---|
| C | wt % | 88.8 | 86.40 | 87.40 | 88.10 | 87.10 |
| H | wt % | 7.19 | 13.14 | 12.14 | 11.78 | 12.66 |
| O | wt % | 3.81 | <0.1 | <0.1 | <0.1 | <0.1 |
| N | wtppm | 110 | <0.2 | <0.2 | 0.4 | <0.2 |
| S | wtppm | 78.0 | 1.2 | 0.4 | 0.4 | 0.8 |
| H/C | at/at | 0.97 | 1.83 | 1.67 | 1.60 | 1.74 |

Group Identity by MS

| | | | | | | |
|---|---|---|---|---|---|---|
| Phenols/Furans | wt % | 11.3 | 0 | 0 | 0 | 0 |
| Naphthenes non | wt % | | 3.7 | 6.8 | 3.7 | 7.0 |
| condensed CₙH₂ₙ | | | | | | |
| Naphthenes condensed | wt % | | 87.4 | 44.9 | 33.7 | 59.8 |
| CₙH₂ₙ₋₂ and CₙH₂ₙ₋₄ | | | | | | |
| Alkylbenzenes CnH₂ₙ₋₆ | wt % | | 1.8 | 8.5 | 9.6 | 6.7 |
| Tetralins CnH2n − 8 | wt % | | 3.7 | 30.4 | 41.4 | 18.4 |
| Naphthalenes CnH2n − 12 | wt % | 62.4 | 1.3 | 6.6 | 8.9 | 4.6 |
| Acenaphthenes and | wt % | | 0.6 | 1.0 | 1.2 | 1.0 |
| Diphenyls CnH2n − 14 | | | | | | |
| Acenaphthylenes and | wt % | | 0.5 | 0.5 | 0.4 | 0.6 |
| Fluorenes CnH2n − 16 | | | | | | |
| Phenanthrenes and | wt % | | 0.2 | 0.3 | 0.2 | 0.3 |
| Anthracenes CnH2n − 18 | | | | | | |
| Benzothiophenes CnH₂ₙ₋₁₀S | wt % | | 0.6 | 0.7 | 0.7 | 1.0 |
| Dibenziothiophenes | wt % | | 0.2 | 0.3 | 0.2 | 0.6 |
| CnH2n − 16S | | | | | | |
| Saturates | wt % | 0.1 | 91.1 | 51.7 | 37.4 | 66.8 |
| Monoaromatics | wt % | 8.2 | 5.5 | 38.9 | 51 | 25.1 |
| Diaromatics | wt % | 4.6 | 2.4 | 8.1 | 10.5 | 6.2 |
| Triaromatics | wt % | 0.7 | 0.2 | 0.3 | 0.2 | 0.3 |
| Total aromatics | wt % | 91.8 | 8.1 | 47.3 | 61.7 | 31.6 |
| Sulfur compounds | wt % | | 0.8 | 1.0 | 0.9 | 1.6 |

Examples 4 through 7 show that renewable jet fuel blending components can be produced in excellent yields from a portion of the products of a catalytic pyrolysis process in a conventional hydrogenation process at temperatures in the 330-340° C. range and pressures of hydrogen in the 90-120 barg range. The sulfur content and freezing points of the products are all well within the range of Jet A-1 specifications. At two conditions the aromatics content is within the specifications of Jet A-1 (<25%), and at the highest pressure, 120 barg in Example 4, the naphthalenes are within the Jet A-spec (<3%).

All of the product mixtures show maximum boiling points above the Jet A-1 specification, but also show that 97% of the material boils within the Jet A-1 specification. A simple distillation can remove the heavier materials, for example by the processes shown in FIG. 5, 6, or 7.

The densities of the product mixtures are all above the Jet A-1 specification, so these materials cannot be used as jet fuel directly, and must be blended. However, the higher densities allow the fuel blends to contain more of the low density paraffins such as linear alkanes, 2- and 3-methyl alkanes, 2,2-dimethyl alkanes, and alkyl pentanes and hexanes, all of carbon numbers 10-16.

The aromatics content of the blendstocks can also be an advantage in jet fuel blending. The higher aromatic products from Examples 5 and 6, for example, could be good blending stock for jet fuel stocks that are lean in aromatics, and the products from Examples 4 and 7 could be blended with jet fuels that are already high in aromatics to reduce the aromatics content below the 25% limit.

When numerical lower limits and numerical upper limits are listed herein, ranges from any lower limit to any upper limit are contemplated.

1. A process for preparing renewable jet fuel blendstock comprising:
a. feeding biomass, catalyst, and optionally transport fluid to a catalytic pyrolysis process fluidized bed reactor maintained at reaction conditions to manufacture a raw fluid product stream containing renewable aromatics,
b. feeding the raw fluid product stream of a) to a solids separation and stripping system to produce separated solids and a fluid product stream,
c. feeding the fluid product stream of b) to a fractionation system in order to recover a fraction boiling at 180° C. to 300° C.,
d. hydrogenating at least a portion of the fraction generated in c) with hydrogen at hydrogenation conditions to produce a hydrogenated fraction containing naphthenes, suitable as jet fuel blendstock, and
e. optionally recovering the jet fuel blendstock comprising naphthenes from the hydrogenated fraction of d) in a product recovery system.

2. The process of claim 2, wherein the biomass is wood, forestry waste, corn stover, agricultural solid waste, municipal solid waste, digestate, food waste, animal waste, carbohydrate, lignocellulosic material, xylitol, glucose, cellobiose, hemicellulose, lignin, or combinations thereof.

3. The process of claim 1, wherein the renewable aromatics comprise benzene, toluene, indane, indene, 2-ethyltoluene, 3-ethyltoluene, 4-ethyltoluene, trimethylbenzene, ethylbenzene, styrene, cumene, n-propylbenzene, xylene, naphthalene, methylnaphthalene, anthracene, methyl anthracene, 9,10-dimethylanthracene, pyrene, phenanthrene, dimethyl naphthalene, ethyl naphthalene, 1-indenol, acenaphthalene, phenol, cresol, benzofuran, naphthalenol, methyl naphthalenol, dimethyl-naphthalenol, aniline, indole, or a combination thereof.

4. The process of claim 1, wherein the renewable aromatics in a) comprise at least 25 volume % naphthalene, substituted naphthalenes, naphthalenols, methyl naphthalenols, and naphthalene diols, and at least 3 weight % xylenols, and less than 15 weight % the sum of phenanthrene, anthracene, and other materials.

5. The process of claim 1, wherein at least a portion of the fluid product stream of b) is hydrotreated to remove heteroatoms.

6. The process of claim 1, wherein the catalyst for the hydrogenation in d) comprises at least one Group VIII metal, and at least one Group VI metal, supported on alumina, silica, silica-alumina, a mixture of alumina and silica; or the catalyst is a zeolitic catalyst, or a noble metal catalyst where the noble metal is one or more of rhodium, ruthenium, iridium, palladium, and platinum, or a combination thereof.

7. The process of claim 1, wherein hydrogenation in d) is at a reaction temperatures of 200° C. to 400° C. and a hydrogen pressure of 4.0 MPa to 12 MPa.

8. The process of claim 1, wherein hydrogenation is carried out at a liquid hourly space velocity greater than 0.1 hr-1 and a volumetric ratio of gas to liquid at reactor operating conditions of 0.1 to 20:1.

9. The process of claim 1, wherein the hydrogenated fraction in d) suitable as jet fuel blendstock comprises at least 50% by weight hydrocarbons with from 10 to 16 carbon atoms.

10. The process of claim 9, wherein the hydrogenated fraction comprises tetralins, decalins, or substituted tetralins or decalins.

11. The process of claim 10, wherein the hydrogenated fraction comprises 30 to 98 wt % naphthenes, from 3 to 50 wt % tetralins, no more than 30 wt % naphthalenes and alkyl naphthalenes, no more than 0.1 wt % sum of acenaphthenes, acenaphthylenes, fluorenes, phenanthrenes, and anthracenes.

12. The process of claim 1, further comprising feeding the fluid product stream of b) to a quench vapor/liquid separation system utilizing hydrocarbon quench or cooling to produce a liquid phase stream comprising oxygenates, and C9+ aromatics, and entrained char, coke, ash, catalyst fines, and a vapor phase stream comprising carbon monoxide, carbon dioxide, hydrogen, olefins, and aromatics, said aromatics of the vapor phase stream comprising benzene, toluene, xylenes, phenols, naphthols, benzofuran, ethylbenzene, styrene, naphthalene, methylnaphthalene, or combinations thereof, prior to fractionating in c).

13. The process of claim 1, further comprising separating 3-ring species in fractionation c) and recycling said species to pyrolysis in a).

14. The process of claim 1, further comprising conducting d) as a first hydrogenation at 2.0 to 7.0 MPa with a CoMo containing catalyst, producing a partially hydrogenated stream of partially hydrogenated aromatic rings, reducing xylenols to benzene, toluene, and xylenes, and reducing naphthalenes to naphthenes, and a second hydrogenation of aromatics to produce alkanes, with a noble metal catalyst containing Pd, or Pt, or a combination thereof, at a pressure of 2.0 to 8.0 MPa that is higher than the pressure of the first hydrogenation.

15. A jet fuel blendstock produced by a process of claim 1.

16. A jet fuel blendstock produced by a process of claim 9.

17. A jet fuel blendstock produced by a process of claim 11.
